(19) United States
(12) Patent Application Publication
(10) Pub. No.: US 2004/0187016 A1
(43) Pub. Date: Sep. 23, 2004

(54) Method for protecting content stored on an information carrier

(76) Inventors: Robert Albertus Brondijk, Eindhoven (NL); Maurice Jerome Justin Jean-Baptiste Maes, Eindhoven (NL)

Correspondence Address: Corporate Patent Counsel, Philips Electronics North America Corporation, P O Box 3001, Briarcliff Manor, NY, 10510, US

(21) Appl. No.: 10/482,144

(22) PCT Filed: Jul. 4, 2002
(86) PCT No.: PCT/IB02/02741

(30) Foreign Application Priority Data
Jul. 6, 2001 (GB) 0116496.1
Jan. 24, 2002 (EP) 02075291.1

(51) Int. Cl. H04L 9/00

(52) U.S. Cl. 713/200

(57) ABSTRACT

The invention relates to a method for protecting content comprising embedded copy protection data stored on an information carrier. In order to avoid that a user illegally circumvents a copy protection mechanism such as a watermark protecting said content to get an illegal access to said content, a method comprising the following steps is proposed:

reading content from or writing content to the information carrier in response to an access command,

storing said content in a memory,

continuing to read content from or to write content to the information carrier and accumulating said content in said memory until enough content is stored therein to extract and evaluate said copy protection data.

The invention relates to a method and a corresponding apparatuses for protecting content stored on an information carrier, to a computer program for performing the method and to an information carrier storing the computer program.

Nowadays, “embedded data” (also called “digital watermarking”) is a technique used to embed copy control information in copyrighted material, such as music, movies and all kinds of audiovisual works. Watermarks may, for instance, be embedded in an audio or a video stream.

These watermarks may represent information indicating that the content, in which it is embedded, is e.g. never to be copied onto removable, optical media, or, indicating that the content should not be present on removable, optical media in unencrypted form. By way of example, a “Never Copy” video watermark, in unencrypted content on a recordable DVD disc, might be illegal, and might trigger a refusal to play back such content by compliant players. Another example is an audio watermark, indicating that content should only be recorded in encrypted form, which can be used to prevent the recording of audio content on a CD-RW, rewritable DVD or any other kind of optical disc.

Digital watermarking techniques typically require a significant amount of data to be examined before a reliable detection is possible. It may happen that several seconds of audio or video material, or derived data thereof, are being “accumulated”, and that the detection is then performed on the accumulated data.

One way of embedding data in a copyrighted material is disclosed in International Application WO 99/45705, which document is hereby enclosed by reference. As the person skilled in the art is familiar with existing techniques for embedding data (or watermarking) and as the invention is not related to techniques for embedding data, no further information is given.

In the practical implementation of play control and record control rules in a PC environment, the inventors have identified several problems related to the specific operations of a PC drive, and to the fact that the user can control the operations of the drive.

A first problem identified by the inventors is that a user can try to circumvent play control, by sending multiple “read” commands to a drive, until the watermark (WM) is found. When the watermark is found and the “reading” is interrupted, the user can simply initiate new “read” commands from the same disc. Since watermark detection often requires a significant amount (seconds) of data to be read, such an attack may be feasible. Similarly, for record control, “write” commands can be sent until the watermark is detected, but after the interruption, the process is simply continued.

A second problem identified by the inventors is that drives need not “read” or “write” audiovisual information sequentially, but the drive can process random portions from an audiovisual work in random order. A hacker may write data to the drive while at the same time reading data from it. The purpose of this hack is to confuse the watermark detector by subjecting it to 2 different streams. The watermark detector may malfunction:

i. because of syntactic (MPEG) errors

ii. because of incompatible payloads of blocks that are read and written

iii. because it declares a watermarked stream unwatermarked (the watermark in one stream is diluted by the other non-marked stream)

iv. because it declares an unwatermarked streams watermarked (the watermark of the other stream affects the non-marked stream).

A third problem identified by the inventors is that it is possible to read or write protected data, using alternation of “read” and “write” actions of short pieces of content which are too small to allow for watermarks to be detected. The idea behind this hack is to do a “butterfly”-read (also known as “small read”): the desired (watermarked) sectors of video are not read contiguously, but interspersed with other data which is not (yet) desired. The intent of the hack is that the watermark detector never collects enough watermark energy between the “jumps” to create a decision above threshold. A derived scheme is one whereby the host reads the sectors in random order and permutes them back to the original order in the main memory. The same idea may be applied for writing watermarked data (copy-never or copy-no more) to a disc. In a straightforward implementation, a drive would then need two watermark detectors, which is expensive, or it would reset after each read or write action, thus enabling the described hack.

The invention has for an object to overcome the problems identified by the inventors, particularly the second and third problem, so as to avoid that a user illegally circumvents a copy protection mechanism such as a watermark protecting said content and gets an illegal access to said content.

This object is achieved according to the present invention by a method as claimed in claim 1, comprising the steps of:

reading content from or writing content to the information carrier in response to an access command,

storing said content in a memory,

continuing to read content from or to write content to the information carrier and accumulating said content in said memory until enough content is stored therein to extract and evaluate said copy protection data.

The invention is based on the idea not reset the watermark detector when different “read” or “write” commands are initiated, but to continue the “accumulation” of the data needed for a detection, regardless of the order in which segments are being read or written, and regardless of interruptions between these read or write actions from the same information carrier. Thus also the “alternate read-write” attack can be prevented by “accumulating” the audio or video data, regardless of whether it is coming from a “read” or “write” action. Copy protection information is collected until it can be completely evaluated so as to detect if it is e.g. allowed to read data from or to write data to the information carrier.

Preferred embodiments of the invention are defined in the dependent claims.

According to a first preferred embodiment the access to the information carrier is controlled on the basis of the extracted and evaluated copy protection information which preferably comprises a watermark which may comprise the information if and how often data read from the information carrier are allowed to be copied, if data are allowed to be written to the information carrier or if data have to be encrypted before writing it.

According to another aspect of the invention any new access commands such as read, write or copy commands during reading or writing content are delayed until in response to the previous access command enough content is accumulated and stored in the memory to extract and evaluate said copy protection data. In this way the above described problems where a hacker tries to avoid the detection of a watermark by small read or write commands or by mixing read and write commands can be effectively avoided. Any new command will not be executed before in response to a previous command the copy protection data from the content handled by the previous command is completely evaluated. A new access command may even not be dealt with if the copy protection data will then lead to a refusal of the access at all.

According to still another aspect of the invention, in case of a new access command during execution of a previous access command, a reset of the extraction and evaluation of the copy protection data is prevented until said copy protection data are completely extracted and evaluated. Usually, a watermark detector operating on a discontinuous stream would be resetted. Such a reset is prevented according to the present invention; instead a resynchronization is performed and content is further accumulated, e.g. into a fold-buffer of a watermark detector such that a watermark detection can be triggered if enough data is accumulated.

The proposed solution can be used in, but is not limited to, all PC drives which can read data from or write data to information carriers, particularly recordable or rewritable optical record carriers, such as CD, DVD or DVR information carriers. Such optical record carriers usually carry a unique number which can easily be used as identifier in the above described sense.

The invention relates also to an apparatus for protecting content stored on an information carrier as claimed in claim 7 comprising a reading unit, a memory, a control unit and a copy protection evaluation unit. Further, the invention relates to a personal computer comprising a drive as claimed in claim 8, a computer program as claimed in claim 9 and an information carrier as claimed in claim 10 storing a computer program as claimed in claim 9.

The invention will now be explained in more detail with reference to the drawings, in which:

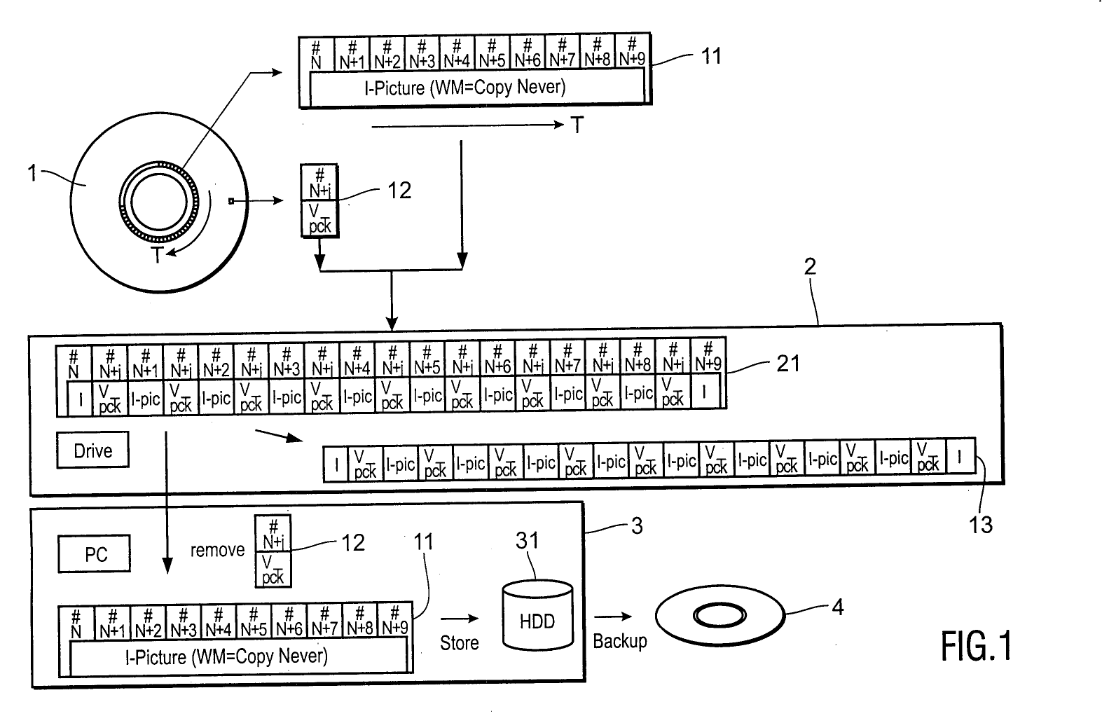

FIG. 1 illustrates the problem of butterfly-reading,

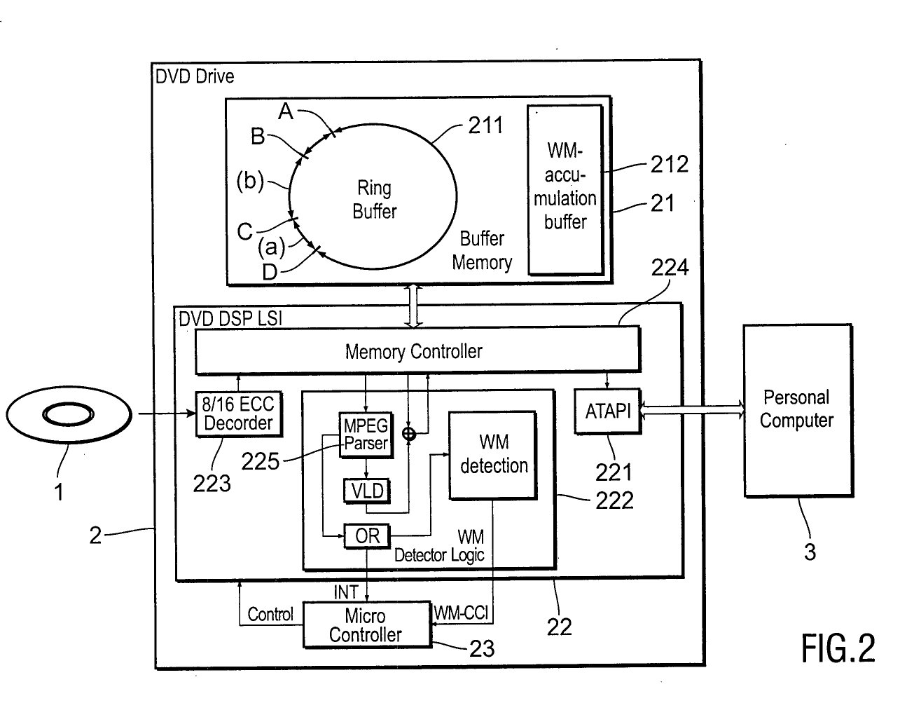

FIG. 2 shows a block diagram of an apparatus according to the invention and

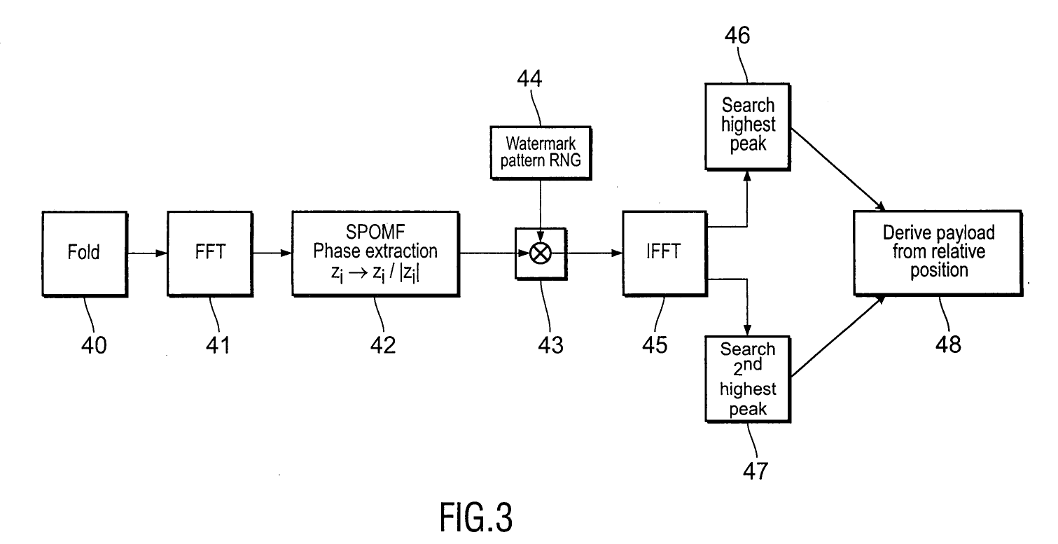

FIG. 3 shows a block diagram of a watermark detector.

By way of an example, the following preferred embodiment of a video watermark in the DVD “Copy Never” context is described.

In general, a DVD PC drive only understands “read command+data” and “write command+data”. The data is always transmitted in units of 2KB (this is called a sector), in a maximum burst of 32 sectors (under Windows and most other operating systems). This implies that a drive has no notion of large contiguous sequences like a video recorder. For this reason, the watermark guidelines have to be tailored to speak in terms of “sectors”, “read” and “write”.

FIG. 1 illustrates the problem to be solved by the present invention. Shown are a disc 1, a DVD drive 2 for accessing the disc 1 and a PC 3 for processing the data read from the disc 1 by the drive 2. It is assumed that the disc 1 comprises an illegal copy of a CSS (Content Scrambling System) DVD-Video. Shown are further a frame 11 of 10 ECC blocks containing one I-picture including a “copy never” watermark. Usually said 10 ECC blocks #N to #N+9 of said frame 11 are read subsequently and processed further. A watermark detector present within the drive 2 would then be able to extract the watermark embodied in said data 11 and to evaluate it. Since the watermark is “copy never” it would then be prevented that said data are further copied by the PC 3.

To avoid this the desired (watermark) sectors of video of the frame 11 are not read contiguously, but interspersed with other data which is not (yet) desired. As a particular example illustrated in FIG. 1, after every desired sector of the frame 11, the PC 3 always requests via the drive 2 a (fixed) dummy sector 12 having serial number #N+j including another video pack V_pck. Said alternate reading of single blocks of the frame 11 and the dummy block 12 leads to a data stream 13 stored in the buffer memory 21 of the drive 2. Since therein each second block contains data of a different data stream, i.e. from either an I-picture (I) or from another video pack (V_pck) a watermark detector (not shown) included in the drive never collects enough watermark energy between the “jumps” to create a decision above threshold, i.e. a watermark embodied in the data stream can not be extracted and evaluated.

Within the PC 3 the dummy block 12 is then removed from the datastream 13 in the PCs main memory so as to reconstruct the original data stream 11 which may then be stored in a hard disc drive (HDD) 31 from which a backup of the hacked data can be stored on another disc 4.

A derived scheme is one whereby the host reads the sectors in random order and permutates them back to the original order in the main memory of the host. The same hack can be applied for writing watermarked data (copy-never or copy-no more) to a disc. This would, however, only work well for rewritable media but not for a write once (recordable) media. For the latter media there is no possibility to overwrite. Moreover, there is a limitation to the number of jumps or seamless links that can be created on a disc during the writing process.

Another hack based on a similar idea mixes read and write commands when accessing a disc. Thus the watermark detector shall be confused by subjecting it to two different data streams at the same time so that again a watermark can not be extracted and evaluated.

FIG. 2 shows an apparatus for protecting content stored on an information carrier according to the present invention. As in FIG. 1 a PC 3 is used to access an information carrier, in this case a disc 1, via a drive 2 including the apparatus for protecting the content stored on the disc 1. It should be noted that the drive 2 can be a separate device as shown in FIG. 2, but can also be integrated into the PC 3, such as a PC disc drive.

The drive 2 comprises a buffer memory 21 a signal processor 22 and a micro controller 23. The buffer memory 21 comprises a ring buffer 211 for storing the data read from the disc 1 or to be written to the disc 1 and a watermark accumulation buffer 212 for accumulating watermark data extracted from the data read from the disc 1 or to be written to the disc 1 and to be used for evaluation of the watermark. The signal processor 22 comprises an interface (ATAPI) 221 to the PC 3, a watermark detector logic 222 for detecting and evaluating a watermark, an ECC decoder 223 for reading data from the disc and decoding it and a memory controller 224 for controlling said elements of the signal processor 22 and the buffer memory 21. Further a microcontroller 23 is provided for control of the signal processor 22 based on a detected watermark.

According to the present invention the drive 2 reads the non-contiguous sectors from the disc 1 and transfers them to the host 3, like in drives without watermark detectors 222. This means that the watermark detector 222 operates on a discontinuous MPEG-stream. Usually this would reset the watermark detector. According to the present invention, however, the watermark detector 222 resynchronizes and keeps accumulating the data into the fold-buffer of the watermark-detector. When enough data is accumulated, a watermark detection (SPOMF etc.) is triggered, and only then the bold-buffer is flushed.

Requesting even a single sector in most drive-architectures leads to reading ahead much more data of the drive, at least 32k bytes (1 ECC block is the smallest access unit for the error-correction system), but generally much more because most likely the host will request the following sectors next. Therefore, the MPEG-stream supplied to the watermark detector 222 can have relatively long streatches without breaks. In the ring buffer 211(a) indicates a sector requested by the host 3 and (b) indicates the data which the detector 222 may continue to parse.

When the host 3 requests a new sector, at some point the data in the ring buffer 211 is overwritten before the watermark detector 222 can process is. According to the invention the detector 222 continues until the parser 225 which is part of the detector 222 resynchronizes and continues folding/accumulating until it has enough MPEG-data for a watermark detection. In view of the resynchronization, the amount of folded content should be increased to T_{c} seconds, which is the amount of video to be folded in case of a non-contiguous MPEG-stream.

In the ring buffer 211 marker A indicates a raw write pointer from which data from the disc is written into the buffer memory. Data from a corrected write pointer B has been ECC corrected. Data up to ATAPI-read pointer C has been transferred to the host 3. The MPEG-parser 225 in the watermark detector 222 has finally reached the MPEG-parser pointer D.

According to an alternative embodiment the drive 2 performs a read ahead of X bites, X being the amount of data to be read, of the requested data sectors in case of suspect MPEG-video, when suspect MPEG sector-data is requested by the host, and ensures that the watermark detector 222 can process this content. Only then, the drive 2 executes the new request from the host 3. This has the advantage of improved drive performance, i.e. the host does not have to wait for one complete watermark detection, and improved watermark detection, i.e. the sections of continuous MPEG data will be longer. The consequence is that the fold-buffer of the watermark detector is deleted with possibly non-watermarked material, i.e. is deleted from e.g. dummy sectors #N+j shown in FIG. 1.

For write-once media the same method can be applied: the host 3 must write data to the disk 1 in a (more or less) continuous way so that the watermark detector 222 can operate on the drive buffer 21. In practice, these problems may not be too large as a rewritable disc in which almost every ECC block has been written in separate write actions is likely to not function due to the extra link errors.

The invention is also applied to overcome the above described third problem of using mixed read and write commands at the same time. The watermark detector 222 parses both the data in the read-buffer and write-buffer and accumulates/folds both into the same fold-buffer. This will delete the watermark if one stream is watermarked and the other is not. For this reason the amount of detected content has to be increased to X kbytes. Such processing of both streams at the same time with one watermark detector does not lead to false-positives for honest users. Regardless of whether the read-action or the write-action was illegal, content has been transferred to/from the disc in unapproved way, and the disc should therefore be ejected.

FIG. 3 shows the general layout of a watermark detector. In a fold buffer incoming data, e.g. video data, is folded or accumulated, the buffer being a 128×128 buffer. After 1 second of video data, a 2D Fourier transformation is performed in a FFT unit 41. In a SPOMF unit 42 a watermark detection is applied by replacing buffer element zᵢ by zᵢ/|zᵢ|. In a correlation unit 43 the result is correlated with the watermark pattern 44 by performing a dot-product. Thereafter a 2D IFFT is applied in a IFFT unit 45. In search units 46 and 47 the highest peak and the second highest peak (in the sense of their absolute value) are searched. Finally, in a combination unit 48 their relative position vector of these two peaks is combined into a payload. For the payload to be valid this relative vector must lie on a predetermined grid of 128 allowed positions. If so, one considers this a valid micro-decision. For a watermark to be detected a valid macro-decision is needed. Such a valid macro-decision occurs when a single micro-decision with valid payload and two high peaks exceeding threshold T₁ appear or two single micro-decisions with valid and equal payload of two medium-sized peaks exceeding threshold T₂ appear. These two positive micro-decisions have to occur within 60 seconds of each other.

According to this preferred embodiment, the following watermark detection strategy is used. The data drive is to “accumulate” all of the sectors containing DVD video it encounters, independent on whether the sector was transferred in a read or in a write action. The accumulation continues until there is sufficient material for a watermark detection to be performed. This accumulation phase is followed by an analysis phase. If the analysis results in a positive recognition of a watermark, then the drive must feedback this, in some manner, to the user. If the disc is a recordable disc, the drive will then remember its unique disc ID. The unique disc ID will be coupled, in the drives' flash memory, with a number “n”, which is the number of times a watermark has been found on that disc. If that number exceeds a number “N”, all read and write actions will be blocked of that disc for a period of time. What that period of time is, may be influenced by a number of factors: the number of discs a drive can remember or the last time the drive was completely flashed. In any case, the number “N” (a practical value may be 10) is too small for a user to clandestinely copy a movie of several minutes, yet it is large enough for the user to either delete all of his illegal material or copy his legal material from the disc. The only way a user can make a disc, for which n>=N, usable again is to let the drive successfully execute a “format unit” command. After reformatting the disc, the drive must then delete that disc ID from its list of illegal discs. In this way, a user is able to reinstate a previously illegal disc.

The way drives can feedback to the user that a WM has been found could be by the drive giving a “check condition” and placing a new sense code in the sense buffer which tells the user that a “WM Copy Never has been detected”. There after, the drive may choose to e.g. perform a “tray-out” or a pause so that the user clearly realizes that something is wrong and that his transfer action is clearly interrupted.

This preferred embodiment can be summarized as follows:

(accumulation phase:)

the drive accumulates sectors of video information, regardless of the order in which they are read or write,

the drive accumulates sectors of all transferred data, hence for both read as write,

the drives accumulates until it has sufficient material for the analysis phase (analysis phase:)

if a “Never Copy” WM is detected, then the drive shall look if the disc ID is present in the memory, otherwise it will create an entry, in which case “n”=0,

the corresponding “n” will be incremented,

the PC drive may choose to perform a “tray-out” (i.e. the removing of the disc from the drive) or a pause,

if “n”>=“N”, then no read or write actions will be allowed, only the SCSI command “FORMAT UNIT” and the drive will send a “check condition” to the host and place a “Never Copy WM” in the sense buffer (the “sense buffer” is the information which a drive will send to the host in response to the SCSI command “REQUEST SENSE”).

After a disc has been inserted, the drive will look at its disc ID and check if it appears in its database present in the memory. If that disc is already in the database and “n”>=“N”, the actions as above will be taken.

1. A method for protecting content comprising embedded copy protection data stored on an information carrier, comprising the steps of:
reading content from or writing content to the information carrier in response to an access command,
storing said content in a memory,
continuing to read content from or to write content to the information carrier and accumulating said content in said memory until enough content is stored therein to extract and evaluate said copy protection data.

2. The method according to claim 1, wherein access to said information carrier is controlled on the basis of the extracted and evaluated copy protection information.

3. The method according to claim 1, wherein said copy protection data comprises a watermark.

4. The method according to claim 1, wherein any new access commands during reading or writing content are delayed until in response to the previous access command enough content is accumulated and stored in the memory to extract and evaluate said copy protection data.

5. The method according to claim 1, wherein, in case of a new access command during execution of a previous access command, a reset of the extraction and evaluation of said copy protection data is prevented until said copy protection data are completely extracted and evaluated.

6. The method according to claim 1, wherein said information carrier is an optical record carrier, in particular a recordable or rewritable optical record carrier.

7. An apparatus for protecting content comprising embedded copy protection data stored on an information carrier, comprising:
a reading unit for reading content from or writing content to the information carrier in response to an access command,
a memory for storing said content,
control means for controlling access to the information carrier such that the reading unit continues to read content from or to write content to the information carrier and accumulates said content in said memory until enough content is stored therein to extract and evaluate said copy protection data, and
a copy protection evaluation unit for extracting said copy protection data from the content stored in said memory and to evaluate said extracted copy protection data.

8. A personal computer comprising a drive for accessing an information carrier, said drive comprising an apparatus for protecting content stored on said information carrier according to claim 7.

9. Computer program comprising program code means for performing the steps of anyone of the methods as claimed in claims 1 to 6.

10. Information carrier storing a computer program as claimed in claim 9.
